(19) United States
(12) Patent Application Publication
(10) Pub. No.: US 2015/0171437 A1
(43) Pub. Date: Jun. 18, 2015

(54) LAYER DESIGN TO MITIGATE FUEL CELL ELECTRODE CORROSION FROM NON-IDEAL OPERATION

(71) Applicant: GM GLOBAL TECHNOLOGY OPERATIONS LLC, Detroit, MI (US)

(72) Inventor: Anusorn KONGKANAND, Rochester Hills, MI (US)

(21) Appl. No.: 14/518,455

(22) Filed: Oct. 20, 2014

Related U.S. Application Data
(60) Provisional application No. 61/915,178, filed on Dec. 12, 2013.

(51) Int. Cl. H01M 8/04; H01M 8/10

(52) U.S. Cl. CPC H01M 8/04; H01M 8/1002; H01M 2250/20

(57) ABSTRACT

A fuel cell includes an anode catalyst layer, a cathode catalyst layer, and an ion conducting membrane interposed between anode catalyst layer and cathode catalyst layer. A first gas diffusion layer is disposed over anode catalyst layer and a second gas diffusion layer is disposed over the cathode catalyst layer. An anode flow field plate is disposed over the first gas diffusion layer and a cathode flow field plate is disposed over the second gas diffusion layer. A gas-sensing layer is interposed between the anode flow field plate and the anode catalyst layer. Characteristically, the gas-sensing layer has a first electrical resistivity when contacting hydrogen gas and a second electrical resistivity when contacting an oxygen-containing gas, the first electrical resistivity being lower than the second electrical resistivity.

### CROSS-REFERENCE TO RELATED APPLICATIONS

This application claims the benefit of U.S. provisional application Ser. No. 61/915,178 filed Dec. 12, 2013, the disclosure of which is hereby incorporated in its entirety by reference herein.

### TECHNICAL FIELD

In at least one aspect, the present invention is related to fuel cell designs that mitigate electrode corrosion.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel and oxidant to disperse over the surface of the membrane facing the fuel- and oxidant-supply electrodes, respectively. Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells arranged in stacks in order to provide high levels of electrical power.

Unintended carbon corrosion at the fuel cell electrode can occur when air intrudes into the anode channels and creates a H₂/air front (local H₂ starvation). FIGS. 1 illustrates this situation. In FIG. 1, a prior art fuel cell 10 having proton exchange membrane 12 interposed between anode 14 and cathode 16 is depicted. The following electrochemical reaction occurs at the anode 14 due to air is driven by the induced voltage between the anode 14 and cathode 16 in regions where hydrogen is present:

O₂+4H⁺+4e−→2H₂O

This reaction couples to the following reactions on the cathode side which leads to degradation of carbon on the cathode side and concurrent lose in fuel cell performance:

C+2H₂O→4H++4e−+CO₂

2H₂O→4H++4e−+O₂

The anode side bipolar plate/diffusion medium 18 and cathode side bipolar plate/diffusion medium 20 are also shown in FIG. 1. FIGS. 2 depicts a prior art solution in which the anode 14 and cathode 16 are shorted together with shorting resistor 22 to minimize the electrochemical reaction by zeroing the induced voltage. During start-up, hydrogen (H₂) is introduce at wet end 30 and then flows to dry end 32. The hydrogen fills an air-filled anode channel of each cell at a slightly different rate (global hydrogen starvation). Anodes 14, cathodes 16, proton exchanges membranes 12, and shorting resistor 28 are also depicted in FIG. 3. This type of electrode degradation can also be minimized by purging the anode headers 36 during purging step 36). In general, these prior art solutions complicate system control and compromise efficiency.

Accordingly, there is a need for an improved fuel cell design that minimizes carbon corrosion at the electrodes.

### SUMMARY

The present invention solves one or more problems of the prior art by providing in at least one embodiment, a fuel cell having a gas-sensing thin layer. The fuel cell includes an anode catalyst layer, a cathode catalyst layer, and an ion conducting membrane interposed between anode catalyst layer and cathode catalyst layer. A first gas diffusion layer is disposed over anode catalyst layer and a second gas diffusion layer is disposed over the cathode catalyst layer. An anode flow field plate is disposed over the first gas diffusion layer and a cathode flow field plate is disposed over the second gas diffusion layer. A gas-sensing layer is interposed between the anode flow field plate and the anode catalyst layer. The gas-sensing layer has a first electrical resistivity when contacting hydrogen gas and a second electrical resistivity when contacting an oxygen-containing gas. Characteristically, the first electrical resistivity is lower than the second electrical resistivity. It is noted that the gas-sensing layer is typically applied on the anode side of the fuel cell. The layer is made from a material that shows significantly different electrical resistance depending on its surrounding gas type, H₂ and O₂ in particular. This property allows the anode and cathode electrodes to be protected from corrosion when O₂ is present in the anode channel due to the increased electrical resistance of the layer. Note that the increased resistance is only at the air-filled membrane electrode assembly region, while the other H₂-filled region is still operable, hence maximizing efficiency.

In another embodiment, a fuel cell having a gas-sensing thin layer. The fuel cell includes an anode catalyst layer, a cathode catalyst layer, and an ion conducting membrane interposed between anode catalyst layer and cathode catalyst layer. A first gas diffusion layer is disposed over anode catalyst layer and a second gas diffusion layer is disposed over the cathode catalyst layer. An anode flow field plate is disposed over the first gas diffusion layer and a cathode flow field plate is disposed over the second gas diffusion layer. A gas-sensing layer is interposed between the anode flow field plate and the anode catalyst layer. The gas-sensing layer includes semiconducting oxide nanostructures in the form of nanotubes, nanowires, and nanofibers having at least one dimension less than about 30 nanometers. The gas-sensing layer has a first electrical resistivity when contacting hydrogen gas and a second electrical resistivity when contacting an oxygen-containing gas. Characteristically, the first electrical resistivity is lower than the second electrical resistivity.

### BRIEF DESCRIPTION OF THE DRAWINGS

Exemplary embodiments of the present invention will become more fully understood from the detailed description and the accompanying drawings, wherein:

FIG. 1 is a schematic illustrating the electrochemical mechanism in which oxygen in the anode causes carbon degradation;

FIG. 2 is a schematic illustration of a prior art method for reducing carbon degradation in a fuel cell;

FIG. 3 is a schematic illustration of a prior art method for reducing carbon degradation due to uneven hydrogen purging in a fuel cell stack;

FIGS. 4A and 4B are schematic illustrations showing a fuel cell with reduced carbon degradation using a gas-sensing layer;

FIGS. 5A and 5B are schematic illustrations showing a fuel cell with reduced carbon degradation using a gas-sensing layer;

FIG. 6 is a schematic illustration of the method for reducing carbon degradation in a fuel cell even under load conditions;

FIG. 7 is a schematic illustration of the method for reducing carbon degradation in a fuel cell stack even under load conditions.

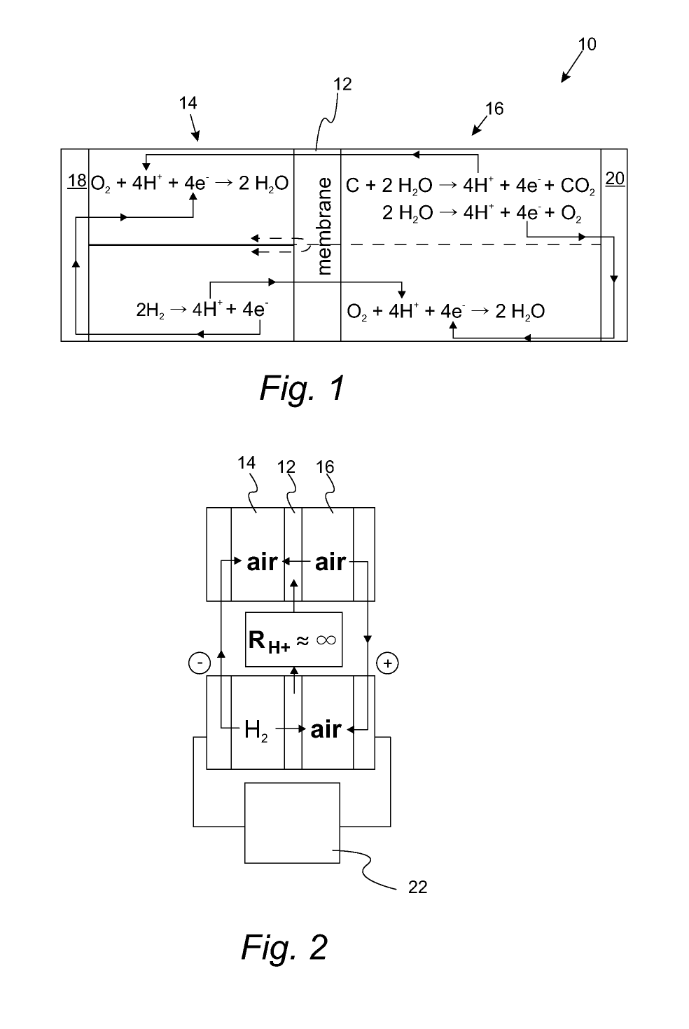

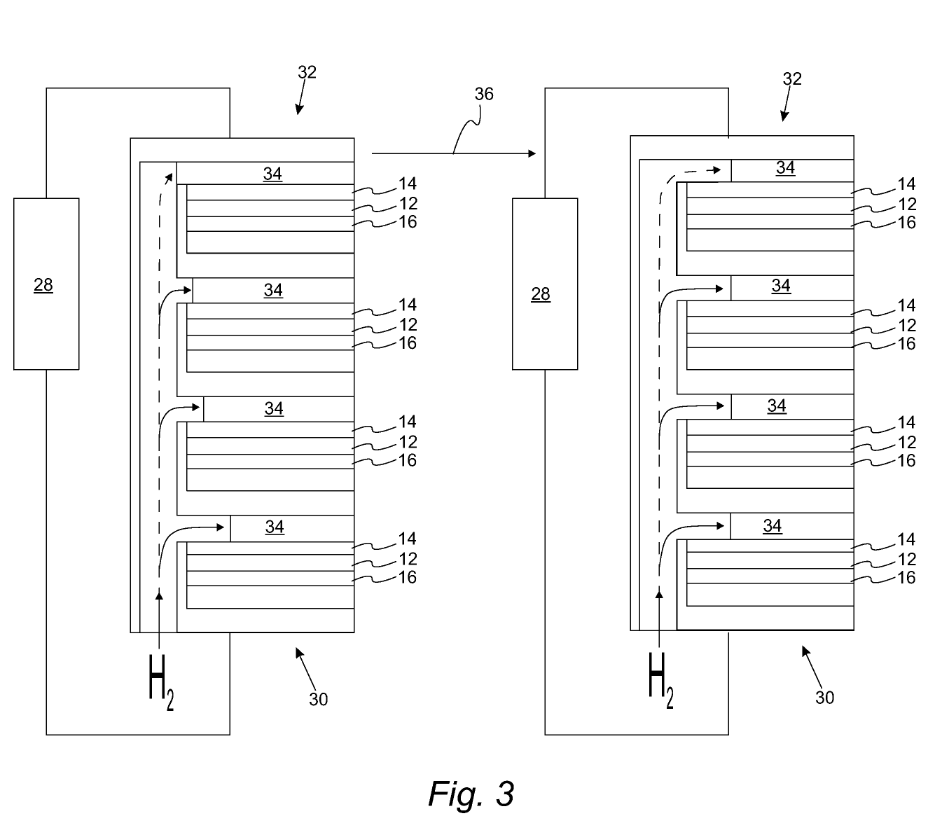

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

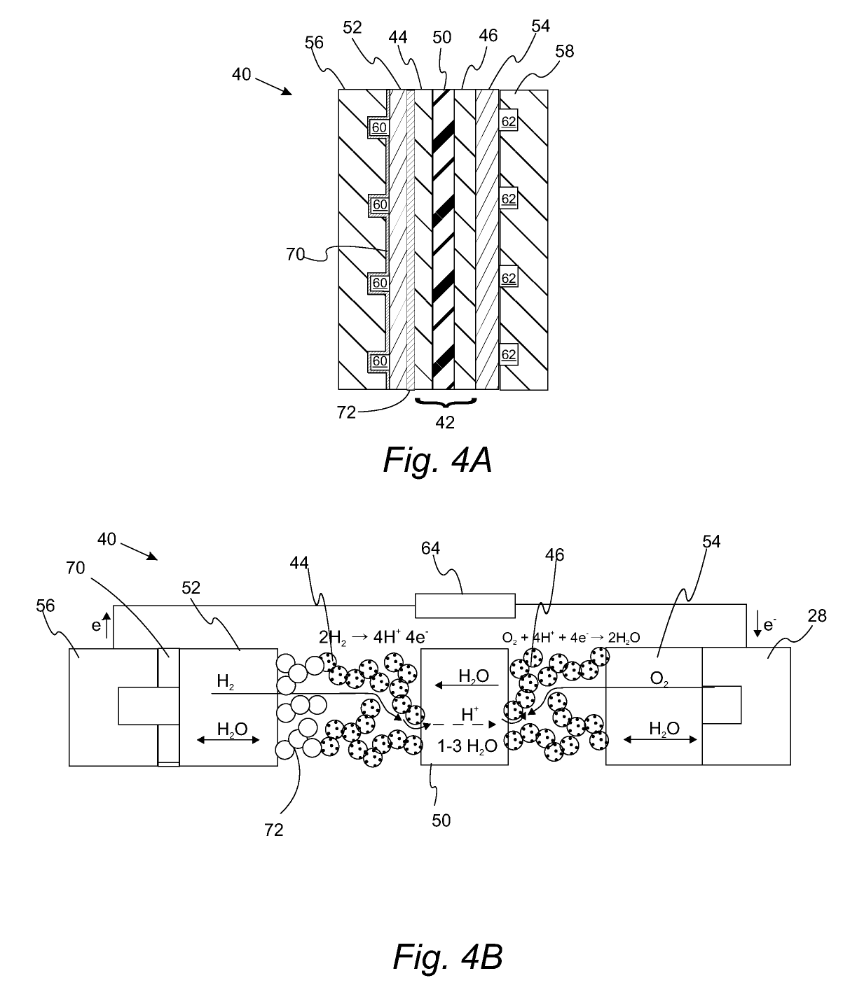

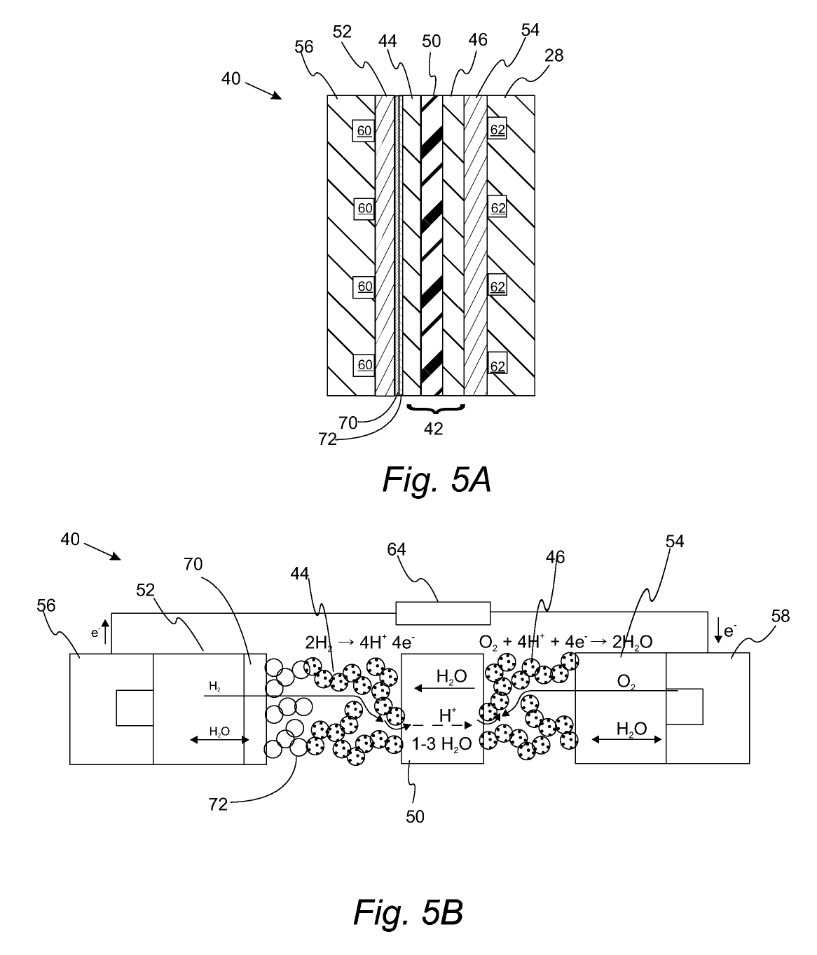

With reference to FIGS. 4A, 4B, 5A, and 5B, a fuel cell having a gas-sensing thin layer is provided. Fuel cell 40 includes the membrane electrode assembly 42 which includes anode catalyst layer 44, cathode catalyst layer 46, and ion conducting membrane (i.e., proton exchange membrane) 50. Proton (i.e., ion) conducting membrane 50 is interposed between anode catalyst layer 44 and cathode catalyst layer 46 with anode catalyst layer 44 disposed over the first side of proton conducting membrane 50 and cathode catalyst layer 16 disposed over the second side of proton conducting membrane 50. Fuel cell 40 also includes porous gas diffusion layers 52 and 54. Gas diffusion layer 52 is disposed over anode catalyst layer 44 while gas diffusion layer 54 is disposed over cathode catalyst layer 46. Microporous layer 72 is also shown to be interposed between gas diffusion layer 52 and anode catalyst layer 44. Fuel cell 40 includes anode flow field plate 56 disposed over gas diffusion layer 52 and cathode flow field plate 58 disposed over gas diffusion layer 54. Each of anode flow field plate 56 and cathode flow field plate 58 independently define flow channels therein. A fuel such as molecular hydrogen gas is flowed through the anode flow channels 60 while an oxygen containing gas such as air is flowed through flow channels 62. Load 64 is also depicted in FIG. 4B and 5B.

In general, gas-sensing layer 70 is interposed between anode catalyst layer 44 and anode flow field plate 56. In a refinement, gas-sensing layer 70 has a thickness from about 5 nm to about 1 micron. In another refinement, gas-sensing layer 70 has a thickness from about 10 nm to about 300 nanometers. In another refinement, gas-sensing layer 70 has a thickness from about 10 nm to about 50 nanometers. In one variation, as depicted in FIGS. 4A and 4B, gas-sensing layer 70 is disposed over anode flow field plate 56. In another variation as depicted in FIGS. 5A and 5B, gas-sensing layer 70 is interposed between anode catalyst layer 44 and gas diffusion layer 52. In a further refinement of FIGS. 5A and 5B, gas-sensing layer 70 is interposed between microporous layer 72 and gas diffusion layer 52. Characteristically, gas-sensing layer 70 is characterized by a first electrical resistivity when it contacts hydrogen and a second electrical conductivity when it contacts oxygen. In particular, the electrical resistivity decreases upon exposure to hydrogen gas and increases upon exposure to oxygen such that the first electrical resistivity is less than the second electrical resistivity.

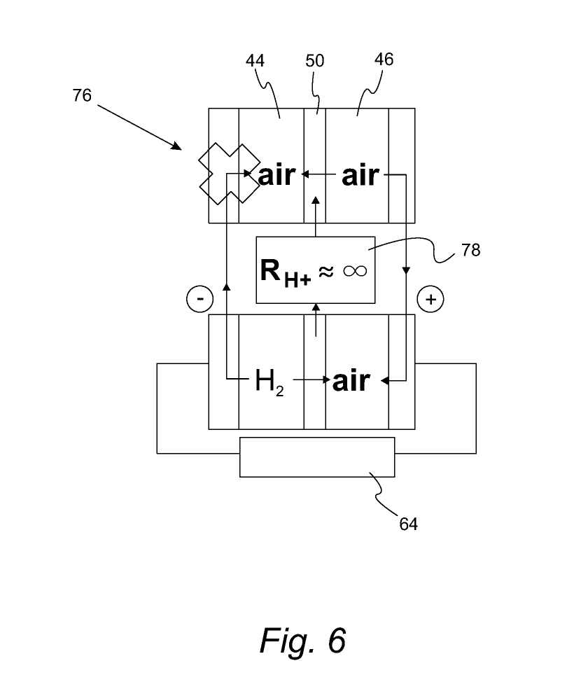

The operation of a fuel cell using such a gas-sensing layer 70 is depicted in FIG. 6. At start up, when there is still oxygen in the anode, electrochemical degradation is inhibited or reduced due to the relatively high resistivity of the regions 76 (the second electrical resistivity) of gas-sensing layer 70 still contacting oxygen. The X symbol represents regions of high resistivity that have not contacted the hydrogen gas yet. At these regions the electrochemical reactions leading to electrode degradation are inhibited. As the hydrogen continues to flow and purge air from the anode 44, gas-sensing layer 70 contacts the hydrogen and the electrical resistivity drops, thereby causing a decrease in electrical resistivity 78. This reduction in electrical resistivity allows the fuel cell to operate properly thereby minimizing the deleterious electrochemical reaction driven by the induced voltage between anode 44 and cathode 46 across proton exchange membrane 50. In a refinement, the second electrical resistivity is at least 5 times greater than the first electrical resistivity. In another refinement, the second electrical resistivity is at least an order of magnitude greater (i.e., 10 times greater) than the first electrical resistivity. In still another refinement, the second electrical resistivity is at least 5 orders of magnitude greater (i.e., 100,000 times greater) than the first electrical resistivity. In still another refinement, the second electrical resistivity is at least 8 orders of magnitude greater (i.e., 100,000,000 times greater) than the first electrical resistivity. In some refinements, the second resistivity is greater than, in increasing order of preference, 1×10³ ohm-cm, 1×10⁴ ohm-cm, 1×10⁵ ohm-cm, 1×10⁶ ohm-cm, or 1×10⁷ ohm-cm. In most cases, the first resistivity is less than about 1×10¹⁵ ohm-cm. In other refinements, the first resistivity is less than, in increasing order of preference, 1×10⁵ ohm-cm, 1×10⁴ ohm-cm, 1×10³ ohm-cm, or 1×10¹ ohm-cm, or 1×10⁷ ohm-cm. In most cases, the first resistivity is less than about 1×10¹⁵ ohm-cm. Typically, the first resistivity is greater than about 1×10⁻³ ohm-cm.

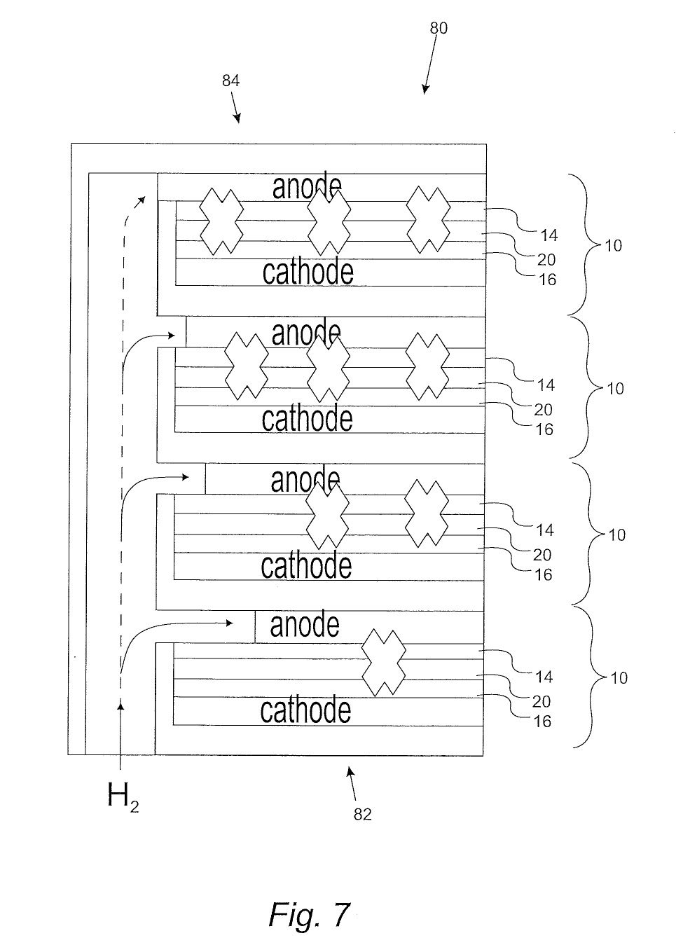

With reference to FIGS. 4A, 4B, 5A, 5C, and 7, the operation of the gas sensing layer in a fuel cell stack is illustrated. As depicted in FIG. 7, the carbon degradation related to the uneven purging of a fuel cell stack 80 is inhibited by the changing resistivity of gas-sensing layer 70. Fuel cell stack includes a plurality of fuel cells 10. Gas-sensing layer 70 in fuels cells in which air is still lingering has a relatively higher resistivity which inhibits electrochemically induced carbon corrosion. In the example depicted in FIG. 7, hydrogen is introduced from wet side 82 flowing towards dry end 84 while successively flow through the fuel cells in that direction. As hydrogen contacts an anode region, the resistivity drops thereby allowing normal fuel cell operation. The X symbols represent regions at startup where the electrochemical reactions leading to carbon degradation are impeded by the high resistance of the gas-sensing layer before those regions contact hydrogen. Gas-sensing layers 70 are typically placed in every cell in a fuel cell stack in order to prevent carbon corrosion. However, they can also be placed in one or more cells in a stack. When the gas-sensing layer 70 is not placed in every cell in the stack, the cells with the gas-sensing layer 70 are designed to be slightly more susceptible to carbon corrosion than the remaining cells in the stack. This can be done by modifying the supply of H₂ to those cells or the tendency of liquid water accumulation. For example, one can locate the cells with gas-sensing layer further away from the H₂ gas inlet, modify the channel dimension, or modify the hydrophilicity of a component. In this case, any change in electrical resistance in the cell with gas-sensing layer indicates the onset of a change in H₂ or O₂ concentration in an anode flow field in the stack. One can then monitor this change in resistance to aid system control in order to operate the fuel cell stack in a more efficient way with less performance degradation.

Gas-sensing layer 70 is typically a semi-conducting oxide layer. Examples of suitable oxide layers include, but are not limited to, titanium oxide (e.g., TiO₂), tin oxide (e.g., SnO₂), zinc oxide (e.g., ZnO), zirconium oxide (e.g., ZrO₂), and the like. In particular, gas-sensing layer 70 is titanium oxide (e.g., TiO₂). In one refinement, gas-sensing layer 70 includes semiconducting oxide nanostructures in the form of nanotubes, nanowires, and nanofibers each independently have at least one dimension less than about 30 nanometers. In another refinement, gas-sensing layer 70 includes semiconducting oxide nanostructures in the form of nanotubes, nanowires, and nanofibers each independently have a diameter from 4 to 20 nanometers. In a further refinement, these semiconducting nanostructures have a length from about 30 nanometers to about 1 micron or alternatively from about 30 nanometers to about 300 nanometers or from about 30 nanometers to 100 nanometers. In another refinement, the semi-conducting oxides include TiO₂ nanotubes have a diameter form about 4 to 15 nm. In a further refinement, the TiO₂ nanotubes have a length from 20 nm to about 1 micron. In still another refinement, the TiO₂ nanotubes have a length from 20 nm to about 200 nm. For example, the electrical resistivity of TiO₂ nanotubes decreases by 8 orders of magnitude when contacted with H₂. Similarly, the electrical resistivity of SnO₂ increases by 1.5 orders of magnitude when it contacts O₂. In particular, semi-conducting oxides with at least one dimension with less than 7 nm show substantial dependency of electrical resistivity on environment gases.

Gas-sensing layer 70 can be prepared by any number of coating techniques known to those skilled in the art of coating technology. For example, a nanostructured semi-conducting oxide can be coated onto the gas-diffusion layer or bipolar plat following by heat treatment (200-400° C.) to improve adhesion. One can also use known techniques such as physical vapor deposition, chemical vapor deposition, or electro-deposition and the alike to deposit thin metal film on the bipolar plate. The metal film can then be converted into a nanostructured semi-conducting oxide gas-sensing layer using known techniques such as electrochemical etching or acid dealloying.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel cell comprising:
an anode catalyst layer;
a cathode catalyst layer;
an ion conducting membrane interposed between anode catalyst layer and cathode catalyst layer;
a first gas diffusion layer is disposed over anode catalyst layer;
a second gas diffusion layer is disposed over the cathode catalyst layer;
an anode flow field plate is disposed over the first gas diffusion layer;
a cathode flow field plate is disposed over the second gas diffusion layer; and
a gas-sensing layer is interposed between the anode flow field plate and the anode catalyst layer, the gas-sensing layer having a first electrical resistivity when contacting hydrogen gas and a second electrical resistivity when contacting an oxygen-containing gas, the first electrical resistivity being lower than the second electrical resistivity.

2. The fuel cell of claim 1 wherein the second electrical resistivity is at least 5 times greater than the first electrical resistivity.

3. The fuel cell of claim 1 wherein the gas-sensing layer is interposed between the first gas diffusion layer and the anode flow field plate.

4. The fuel cell of claim 1 wherein the gas-sensing layer is interposed between the first gas diffusion layer and the anode catalyst layer.

5. The fuel cell of claim 1 further comprising a microporous layer interposed between the first gas diffusion layer and the anode catalyst layer, the gas-sensing layer being interposed between the first gas diffusion layer and the microporous layer.

6. The fuel cell of claim 1 wherein the gas-sensing layer includes a semi-conducting oxide.

7. The fuel cell of claim 1 wherein the gas-sensing layer includes a component selected from the group consisting of titanium oxide, tin oxide, zinc oxide, zirconium oxide, and combinations thereof.

8. The fuel cell of claim 1 wherein the gas-sensing layer includes SnO₂.

9. The fuel cell of claim 1 wherein the gas-sensing layer includes TiO₂ nanotubes.

10. The fuel cell of claim 1 wherein the gas-sensing layer includes TiO₂ nanotubes having a diameter from about 4 to 20 nanometers.

11. A fuel cell comprising:
an anode catalyst layer;
a cathode catalyst layer;
an ion conducting membrane interposed between anode catalyst layer and cathode catalyst layer;
a first gas diffusion layer is disposed over anode catalyst layer;
a second gas diffusion layer is disposed over the cathode catalyst layer;
an anode flow field plate is disposed over the first gas diffusion layer;
a cathode flow field plate is disposed over the second gas diffusion layer; and
a gas-sensing layer is interposed between the anode flow field plate and the anode catalyst layer, the gas-sensing layer including semiconducting oxide nanostructures in the form of nanotubes, nanowires, and nanofibers having at least one dimension less than about 30 nanometers, the gas-sensing layer having a first electrical resistivity when contacting hydrogen gas and a second electrical resistivity when contacting an oxygen-containing gas, the first electrical resistivity being lower than the second electrical resistivity.

12. The fuel cell of claim 11 wherein semiconducting oxide nanostructures have a diameter from about 4 to 20 nanometers.

13. The fuel cell of claim 11 wherein the second electrical resistivity is at least 5 times greater than the first electrical resistivity.

14. The fuel cell of claim 11 wherein the gas-sensing layer is interposed between the first gas diffusion layer and the anode flow field plate.

15. The fuel cell of claim 11 wherein the gas-sensing layer is interposed between the first gas diffusion layer and the anode catalyst layer.

16. The fuel cell of claim 11 further comprising a microporous layer interposed between the first gas diffusion layer and the anode catalyst layer, the gas-sensing layer being interposed between the first gas diffusion layer and the microporous layer.

17. The fuel cell of claim 11 wherein the semiconducting oxide nanostructures includes a component selected from the group consisting of titanium oxide, tin oxide, zinc oxide, zirconium oxide, and combinations thereof

18. The fuel cell of claim 11 wherein the semiconducting oxide nanostructures includes SnO₂.

19. The fuel cell of claim 11 wherein semiconducting oxide nanostructures includes TiO₂ nanotubes.

20. The fuel cell of claim 19 wherein the TiO₂ nanotubes having a diameter from about 4 to 20 nanometers.
